(19) United States
(12) Patent Application Publication
(10) Pub. No.: US 2004/0105019 A1
(43) Pub. Date: Jun. 3, 2004

(54) Camera equipment

(76) Inventors: Shinya Imanishi, Yokohama (JP); Hisao Odawa, Hitachinaka (JP); Tetsuo Nakano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/617,696

(22) Filed: Jul. 14, 2003

(30) Foreign Application Priority Data
Dec. 2, 2002 (JP) 2002-349354

(51) Int. Cl. H04N 5/76

(52) U.S. Cl. 348/231.99; 348/231.6; 348/211.2; 348/211.3

(57) ABSTRACT

A camera equipment includes a first coder for compression-coding a picked-up image for transmission to a network and a second coder for compression-coding the image to store it in a recorder. Even when data cannot be transmitted due to the conditions of a transmission path, the compressed image data can be acquired without fail. The compressed image data before and after an abnormality can be recorded and transmitted in high image quality, and a compression scheme suitable for the expansion decoding scheme at the transmission destination can be selected. The image data generated in a camera unit is compression-coded in according to the expansion decoding scheme at the transmission destination, and transmitted to a network. The same image data thus generated is compression-coded by the second coder using a compression coding scheme in a more finely detailed fashion than that by the first coder.

### BACKGROUND OF THE INVENTION

The present invention relates to a camera equipment for compression-coding a picked-up image into a compressed image data and storing and transmitting the compression-coded data to a communication line such as a network, or in particular to a camera equipment for generating a plurality of compressed image data at the same time from a picked-up image by a plurality of different compression-coding schemes for different purposes.

Practical applications have begun of a WEB camera for compression-coding an image picked up by a camera equipment and transmitting a compressed image data to a personal computer (PC) or the like through an internet and a camera equipment for recording an acquired compressed image data in a recording medium such as a hard disk drive of a camera equipment and subsequently transmitting the compressed image data to a PC or the like through USB (Universal Serial Bus) or LAN.

JP-A-10-28234, for example, discloses an application in which an image data is recorded in an image recorder of a camera equipment and the recorded image is transmitted upon detection of an abnormality.

In the application disclosed in JP-A-2000-59758, on the other hand, different compressed image data are generated at different compression rates by the same compression scheme, and the image data compressed at a high compression rate are transmitted in such a manner as not to exceed the transmission capacity of a transmission path, while at the same time recording the compressed image data generated at a lower compression rate and having a higher image quality than the compressed image data transmitted to the transmission path.

With reference to FIG. 2, an explanation will be given about a case in which an image data is recorded in an image recorder of a camera equipment and the recorded image is transmitted upon detection of an abnormality. FIG. 2 is a block diagram for explaining a general configuration of a camera equipment according to the prior art. In FIG. 2, reference numeral 200 designates a camera equipment, numeral 201 a camera unit for picking up an image and generating an image data, numeral 202 an image recorder for storing the image data acquired at the camera unit 201, numeral 203 a controller for controlling the overall operation of the camera unit 200, numeral 204 a coder for compression-coding the image data, numeral 205 a data communication unit for transmitting the compressed image data to a transmission path such as Ethernet (registered trade name) or a telephone line, and numeral 206 an abnormality detector for detecting an abnormality which may occur in the camera unit 200.

In the case where the abnormality detector 206 detects an image abnormality or such other abnormalities as an intrusion or a malfunction of the camera unit 200 while the image data acquired at the camera unit 201 is being recorded in the image recorder 202, the abnormality is notified to the controller 203. Upon receipt of the abnormality notice, the controller 203 controls the data communication unit 205 to maintain communication, controls the coder 204 to compression-code the image data recorded in the image recorder 202 at the time of the abnormality, and transmits the same compressed image data as of the time of the abnormality through the data communication unit 205. Thus, an image picked up at the time of the abnormality can be transmitted to the destination of transmission image. In this way, the conventional camera equipment 200 stores the image data in the image recorder 202 and transmits the stored image upon detection of an abnormality.

Also, in the prior art, different compressed image data are generated at different compression rates by the same compression scheme, and the image data compressed at a high compression rate are transmitted in such a manner as not to exceed the transmission capacity of a transmission path, while the image data compressed at a lower compression rate and having a higher image quality than the compressed image data transmitted to the transmission path are stored in a recording medium.

As described above, according to the prior art, the images recorded in the image recorder 202 during the detected abnormality are kept stored, while the images before the time of recording are not stored. Also, the images picked up by the image recorder 202 after the abnormality cannot be acquired. Thus, the problem is posed that sufficient information cannot be obtained at the time of an abnormality.

Another problem of the conventional technique is that compressed image data cannot be transmitted to a destination of transmission data having a different compression coding scheme.

### SUMMARY OF THE INVENTION

An object of this invention is to provide a camera equipment in which the required image data can be acquired without failing upon detection of an abnormality, and in which a compression scheme can be selected in keeping with the expansion decoding scheme of the destination.

In order to solve the problems described above, according to one aspect of the invention, there is provided a camera equipment comprising camera means for outputting a picked-up image as an image data, first coding means for compression-coding the image data output from the camera means, second coding means for compression-coding the image data output from the camera means, whose coding is different in kind from that of the first coding means, communication means for transmitting and receiving, through a transmission path, the compressed image data compression-coded by the first coding means, and recording means for storing the compressed image data compression-coded by the first coding means and the second coding means, wherein the first coding means is configured to compression-code the image data by a compression coding scheme designated externally through the communication means.

In the first coding means, an appropriate one of a plurality of different compression coding schemes is selected, and the image data is compression-coded by a scheme designated externally.

With the camera equipment according to an aspect of this invention, the image data is compression-coded in the second coding means by a compression coding scheme designated by an external unit through the communication means.

With the camera equipment according to another aspect of this invention, the first coding means is such that the image data is compression-coded by a compression coding scheme designated by an external unit through the communication means at a transmissible data rate not exceeding the transmission capacity of the transmission path.

With the camera equipment according to another aspect of this invention, the second coding means compression-codes the image data according to a compression coding scheme designated by an external unit through the communication means in a way to generate a more finely detailed compressed image data than the compressed image data compression-coded by the first coding means.

The camera equipment according to another aspect of this invention further comprises abnormality detection means for detecting an abnormality occurring at the image pick-up position and upon detection of an abnormality, notifying the abnormality to an external unit through the communication means.

During an abnormality, information indicating the prevailing abnormality is added to the compressed image data recorded in the recording means.

According to another aspect of the invention, there is provided a camera equipment comprising a camera means for outputting a picked-up image as an image data, first coding means for compression-coding the image data output from the camera means, second coding means for compression-coding the image data output from the camera means, whose compression-coding is different in kind from that of the first coding means, first communication means for transmitting and receiving, through a transmission path, the compressed image data compression-coded by the first coding means, second communication means for transmitting and receiving, through another transmission path, the compressed image data compression-coded by the second coding means, and recording means for storing the compressed image data compression-coded by the first coding means and the second coding means.

The first communication means transmits and receives the image data through a wireless transmission path, and the second communication means transmits and receives the image data through a wire transmission path.

The first coding means and the second coding means, after connection is established for communication, are adapted to compression-code the image data by selectively setting a compression coding scheme as designated by an external unit through the first communication means and the second communication means, respectively.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a general configuration of a camera equipment according to an embodiment of the invention.

FIG. 2 is a block diagram for explaining a general configuration of the camera equipment according to the prior art.

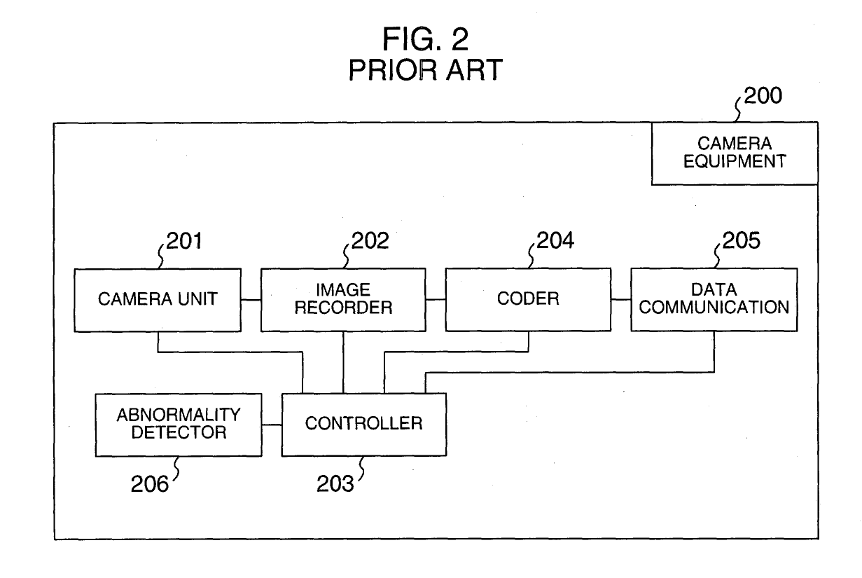

FIG. 3 is a block diagram showing an image receiver for receiving, displaying and recording the compressed image data transmitted by the camera equipment through a transmission path such as a network according to the embodiment of the invention.

FIG. 4 is a diagram showing a configuration of a camera equipment and an image receiver connected to a network according to the embodiment of the invention.

FIG. 5 is a diagram showing the operation sequence of the camera equipment according to the embodiment of the invention connected for communication with an image receiver through a network to start the image data transmission, the operation sequence in case of a communication fault which may be caused by an external disturbance or the like, and the operation sequence for transmitting an image yet to be transmitted.

FIG. 6 is a flowchart showing the operation sequence of the camera equipment according to the embodiment of the invention connected with an image receiver through a network.

FIG. 7 is a flowchart showing the operation sequence for restoring the operation of the camera equipment according to the embodiment of the invention in case of a communication fault which may occur during the transmission of the compressed image data to an image receiver through a network.

FIG. 8 is a flowchart showing the operation sequence of the camera equipment according to the embodiment of the invention for transmitting an untransmitted compressed image data during the transmission of the compressed image data to an image receiver through a network.

FIG. 9 is a block diagram showing a general configuration of a camera equipment according to another embodiment of the invention.

FIG. 10 is a diagram showing the operation sequence of the camera equipment according to the embodiment of the invention connected with an image receiver through a network to start the image data transmission, the operation sequence followed in case of a malfunction of the camera equipment, and the operation sequence for transmitting the compressed image data that have been recorded during an abnormality.

FIG. 11 is a flowchart showing the operation sequence of the camera equipment according to the embodiment of the invention for recording, upon detection of an abnormality, the abnormality information and recording, upon restoration from the abnormality, the abnormality end information, during the transmission of the compressed image data to an image receiver through a network.

FIG. 12 is flowchart showing the operation sequence of the camera equipment according to the embodiment of the invention for transmitting, upon receipt of a request to transmit the compressed image data recorded during an abnormality, an abnormality-related compressed image data to an image receiver through a network during the transmission of the compressed image data.

FIG. 13 is a block diagram showing a general configuration of a camera equipment according to a further embodiment of the invention.

FIG. 14 is a block diagram showing a block configuration of a second image receiver constituting a destination of the compressed image data transmitted by the camera equipment according to the embodiment of the invention.

FIG. 15 is a diagram showing a configuration of a camera equipment and an image receiver according to the embodiment of the invention connected to a wire network and a wireless network.

FIG. 16 is a diagram showing the operation sequence of a camera equipment according to the embodiment of the invention connected with a second image receiver through a wireless network to start the transmission of the image data on the one hand and connected with a first image receiver through a wire network to start the transmission of the image-data on the other hand.

FIG. 17 is a flowchart showing the operation sequence of a camera equipment according to the embodiment of the invention connected with a second image receiver through a wireless network to start the compression coding and the transmission of the compressed image data.

FIG. 18 is a flowchart showing the operation sequence of a camera equipment according to the embodiment of the invention connected with a first image receiver through a wire network to start the compression coding and the transmission of the compressed image data.

### DESCRIPTION OF THE EMBODIMENTS

A camera equipment according to a first embodiment of the invention will be explained with reference to the accompanying drawings.

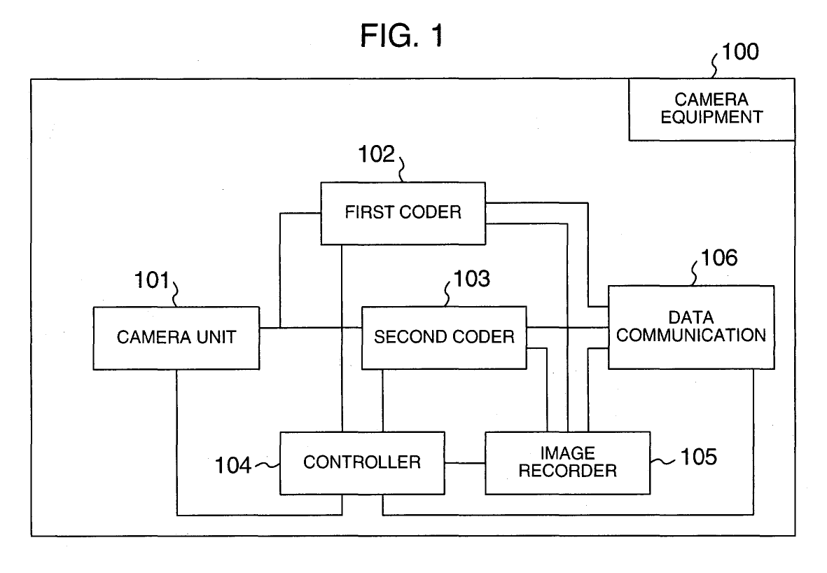

FIG. 1 is a diagram showing an example of the general block configuration of a camera equipment according to the invention. Reference numeral 100 designates a camera equipment, numeral 101 a camera unit for picking up an image and generating an image data, numeral 102 a first coder for coding the image data generated by the camera unit 101, numeral 103 a second coder for coding the image data acquired by the camera unit 101, whose coding scheme is different from that of the first coder, as referred to hereafter, numeral 104 a controller for controlling the overall operation of the camera equipment 100, numeral 105 an image recorder for storing the compressed image data generated, and numeral 106 a data communication unit for transmitting the compressed image data generated by the first coder 102 to a transmission path such as the Ethernet (registered trade name) and the telephone line.

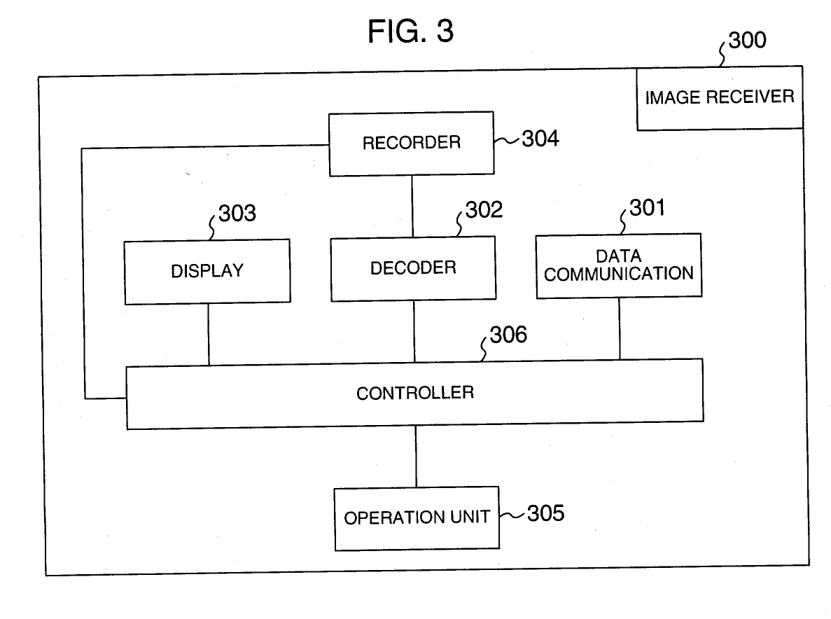

FIG. 3 is a diagram showing an example of the block configuration of an image receiver constituting a transmission destination of the compressed image data transmitted by the camera equipment 100 according to an embodiment of the invention. Numeral 300 designates an image receiver, numeral 301 a data communication unit for transmitting and receiving data to and from the camera equipment 100, numeral 302 a decoder for decoding the compressed image data received from the camera equipment 100, numeral 303 a display unit for converting the image data expanded by the decoder 302 into a video signal and displaying it on a display screen or the like, numeral 304 a recorder for recording the compressed image data received by the decoder 302, numeral 306 a controller for controlling the overall operation of the image receiver 300, numeral 305 an operation unit operating the controller 306.

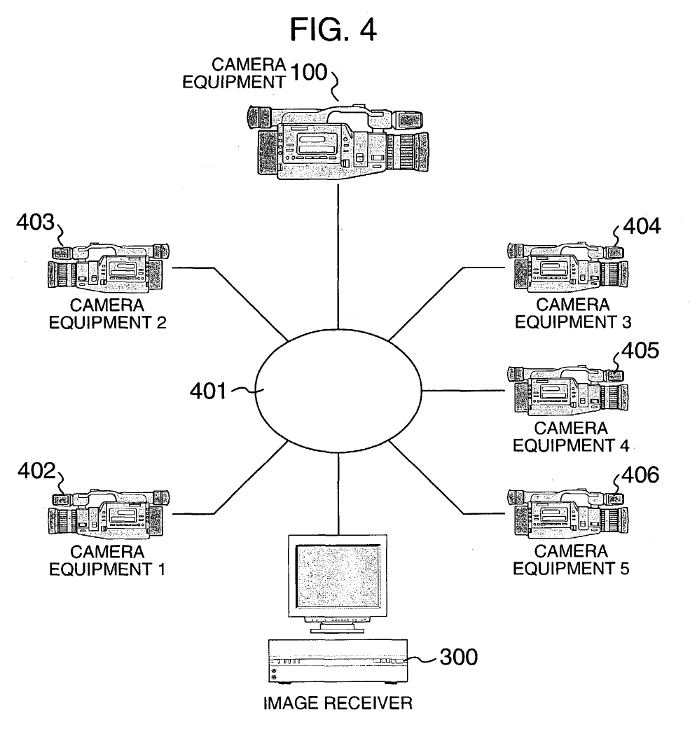

FIG. 4 is a diagram showing an example of a configuration in which the camera equipment 100 according to the embodiment of the invention is connected to other camera equipments and the image receiver 300 through a network. Numeral 401 designates a network, numeral 402 a first camera equipment having the same configuration as the camera equipment 100, numeral 403 a second camera equipment having the same configuration as the camera equipment 100, numeral 404 a third camera equipment having the same configuration as the camera equipment 100, numeral 405 a fourth camera equipment having the same configuration as the camera equipment 100, and numeral 406 a fifth camera equipment having the same configuration as the camera equipment 100.

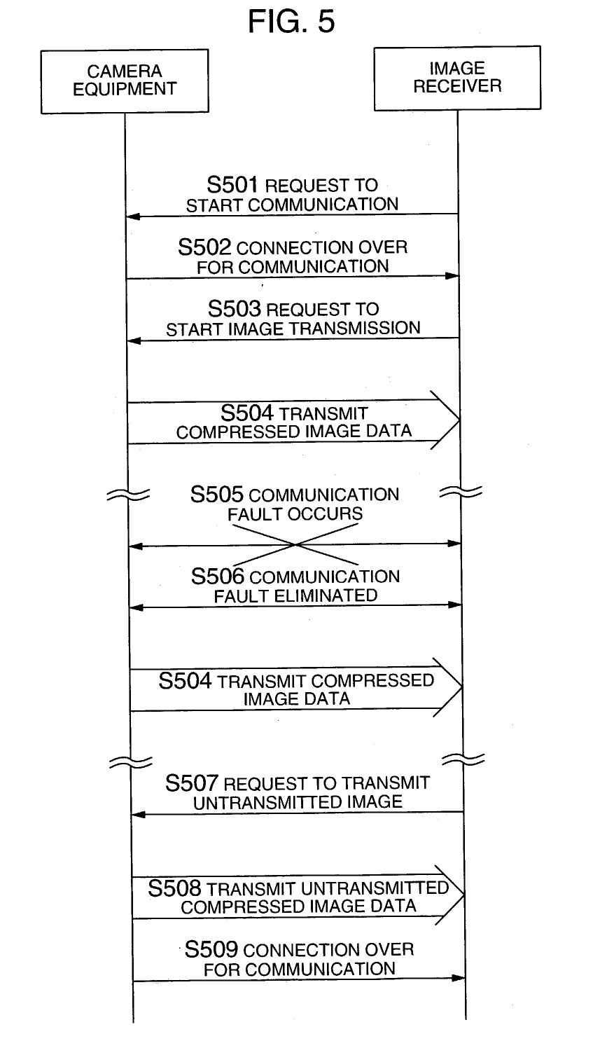

FIG. 5 is a diagram showing the operation sequence of the camera 100 according to the embodiment of the invention connected to the image receiver 300 through the network 401, including the operation sequence for starting the transmission of the compressed image data, the operation sequence followed in case of a communication fault which may occur due to an external disturbance or the like and the operation sequence for transmitting an untransmitted image.

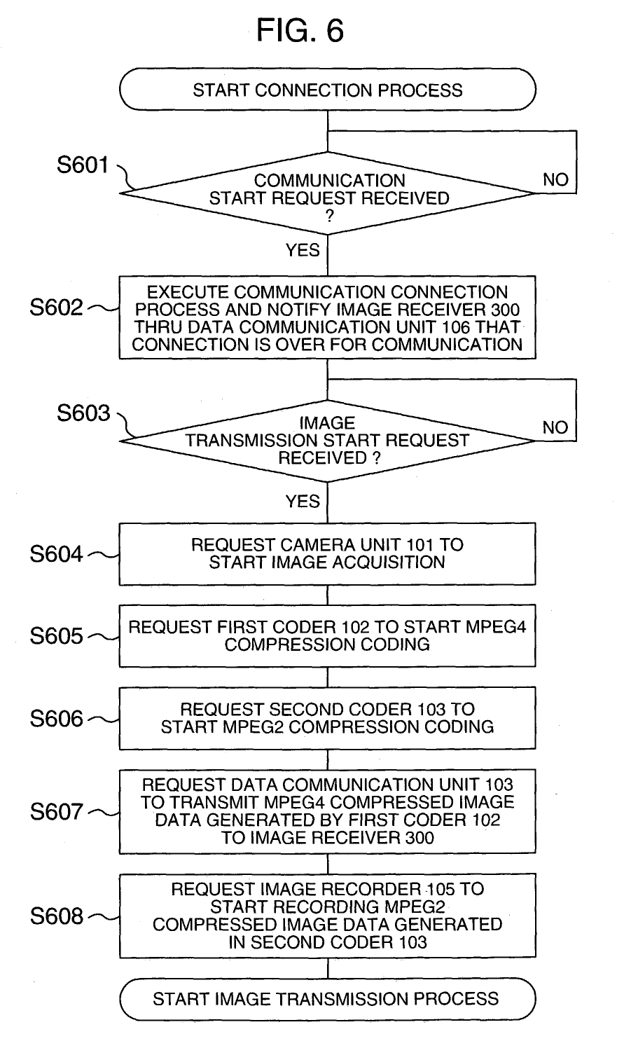

FIG. 6 is a flowchart showing the processing sequence in which the operation of the camera equipment 100 according to the embodiment of the invention connected to the image receiver 300 through the network 401 is controlled by the controller 104.

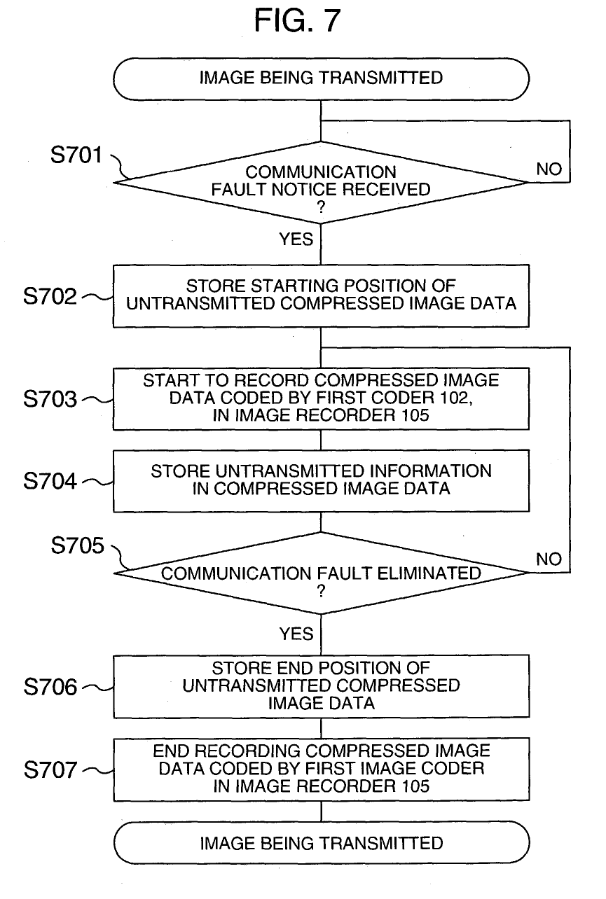

FIG. 7 is a flowchart showing the processing sequence in which the operation of the camera equipment 100 according to the embodiment of the invention connected to the image receiver 300 through the network 401 is controlled by the controller 104 for restoring the normal operation after a communication fault which may occur during the transmission of the compressed image data.

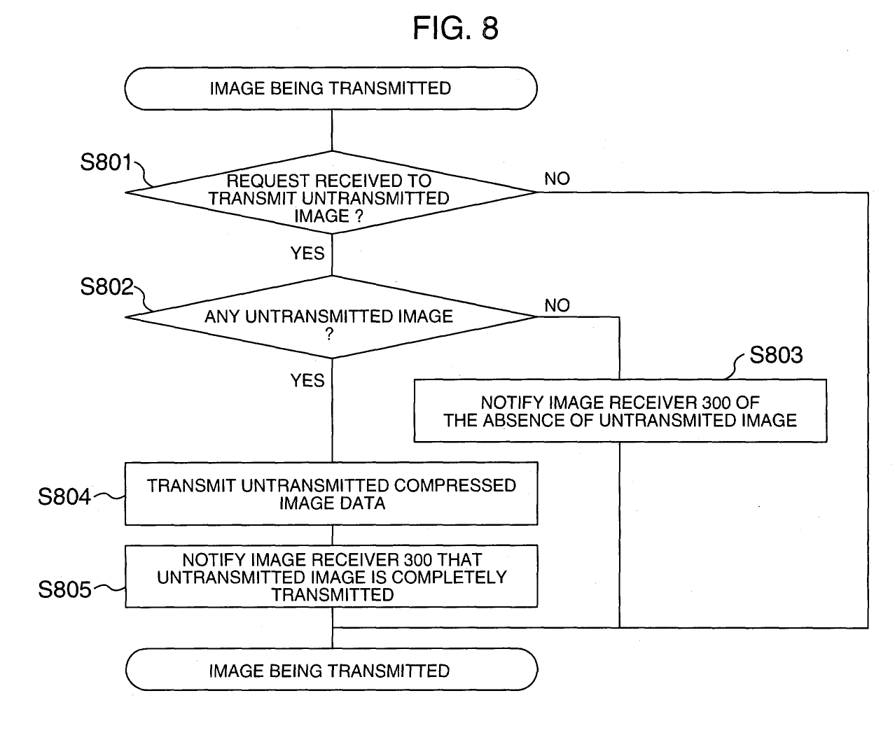

FIG. 8 is a flowchart showing the processing sequence in which the operation of the camera equipment 100 according to the embodiment of the invention connected to the image receiver 300 through the network 401 is controlled by the controller 104 for receiving a request for transmission of a compressed image which remains untransmitted to the image receiver 300 due to a communication fault or the like which may occur during the transmission of the compressed image data.

The operation of the camera equipment 100 according to the embodiment of the invention for transmitting the compressed image data to the image receiver 300 and recording the compressed image data in the image recorder 105 will be explained with reference to FIGS. 1, 3, 4, the operation sequence diagram of FIG. 5 and the flowchart of FIG. 6.

The camera equipment 100 is connected to the network 401 together with a plurality of other camera equipments and the image receiver 300, as shown in FIG. 4. Upon transmission of a communication start request from the image receiver 300 to the camera equipment 100 (S501), the request is sent to the controller 104 after being received by the data communication unit 106. Upon receipt of the communication start request (S601), the controller 104 executes the connection processing for communication and notifies the image receiver 300 through the data receiver 106 that the connection for communication is completed (S502) (S602). Upon receipt of the connection completion notice, the image receiver 300 transmits an image transmission start request to the camera equipment 100 to start the compression coding according to MPEG4 (S503). Upon receipt of the image transmission start request through the data communication unit 106 (S603), the controller 104 issues an image acquisition start request to the camera unit 101 (S604). Further, the controller 104 sends a request to the first coder 102 to start the compression coding according to MPEG4 in such a manner that the image data input from the camera unit 101 is maintained at the transmission rate in keeping with the transmission capacity of the network 401 (S605). The controller 104 also requests the second coder 103 to start the compression coding according to MPEG2 in such a manner that the image data input from the camera unit 101 becomes a more finely detailed image than the compressed image data generated by the first coder 102 (S606). Next, the controller 104 requests the data transmitter 106 to transmit the compressed image data according to MPEG4 generated by the first coder 102, to the image receiver 300 (S607) (S504). Also, the controller 104 requests the image recorder 105 to start recording the compressed image data according to MPEG2 generated by the second coder 103 (S608). In this way, the image data acquired and generated by the camera unit 101 are compression-coded by two types of compression coding schemes including MPEG4 and MPEG2. The image data compressed according to MPEG4 is transmitted to the image receiver 300 through the network 401, while the image data compressed according to MPEG2 is recorded in the image recorder 105.

Next, the operation performed by the camera equipment 100 in case of a communication fault which may occur due to external disturbances or the like of the network 401 during the transmission of the compressed image data to the image receiver 300, will be explained with reference to FIGS. 1, 3, 4, the operation sequence shown in FIG. 5 and the flowcharts of FIGS. 7 and 8.

Assume that a communication fault has occurred due to external disturbances or the like in the network 401 while the compressed image data generated by the first coder 102 is being transmitted to the image receiver 300 (S505). Upon detection of the communication fault, the data communication unit 106 notifies the controller 104 (S701). Upon receipt of the notice, the controller 104 causes the image recorder 105 to store the starting position of the compressed image data that has become impossible to transmit to the image receiver 300 due to the communication fault (S702). From this time on, the compressed image data coded in the first coder 102 ceases to be transmitted. Therefore, the compressed image data coded by the second coder 103 is recorded in the image recorder 105, while at the same time recording the compressed image data coded by the first coder 102 in the image recorder 105 (S703). The compressed image data generated by coding in the first coder 102 and the second coder 103 are thus recorded in the image recorder 105 together with the untransmitted information (S704). After that, the controller 104 regularly checks to see whether the communication fault has been eliminated or not (S705). In the case where the communication fault is not yet eliminated, the untransmitted information are added again in the compressed image data generated by the first coder 102 and the second coder 103 (S704). In the case where the communication fault has been eliminated (S506), on the other hand, the ending position of the untransmitted compressed image data is stored in the image recorder 105 (S706), and the transmission of the compressed image data generated by the first coder 102 is restarted (S504), while at the same time terminating the recording of the compressed image data coded by the first coder 102 in the image recorder 105 (S707).

Upon receipt of an untransmitted image transmission request from the image receiver 300 (S507) (S801), the controller 104 checks to see whether there exists any untransmitted image in the image recorder 105 (S802), and in the absence of an untransmitted image, notifies the image receiver 300 (S803). In the presence of an untransmitted image, on the other hand, the controller 104 transmits the particular untransmitted compressed image data recorded in the image recorder 105 to the image receiver 300 (S508) (S804). Upon complete transmission of all the untransmitted compressed image data, the controller 104 notifies the image receiver 300 that the untransmitted image have been completely transmitted (S509) (S805). Even in the case where the transmission of the compressed image data is suspended due to the degeneration, a fault, etc. of the communication conditions during the transmission of the compressed image data, therefore, the operations described above make it possible to recover the compressed image data acquired during the suspension of the transmission.

The two types of untransmitted compressed image data generated by the first coder 102 and the second coder 103 are recorded in the image recorder 105, and all the untransmitted compressed image data are assumed to be transmitted in the aforementioned case. In the case where the untransmitted compressed image data generated by the second coder 103 cannot be decoded by the decoder 302 of the image receiver 300 by reason of the fact that it is compatible only with MPEG4 or for some other reason, however, only the untransmitted compressed image data generated by the first coder 102 may be transmitted to the image receiver 300.

According to this embodiment, the image data is compression-coded according to MPEG4 by the first coder 102 at the request of the image receiver 300, while the image data is compression-coded according to MPEG2 by the second coder 103 under the control of the controller 104. Nevertheless, the second coder 103 may be set to a different compression coding scheme.

Also, according to this embodiment, the image data is compression-coded according to MPEG4 by the first coder 102 at the request of the image receiver 300, while the image data is compression-coded according to MPEG2 by the second coder 103 under the control of the controller 104. Nevertheless, the second coder 103 may be set to an arbitrary compression coding scheme at the request of the image receiver 300.

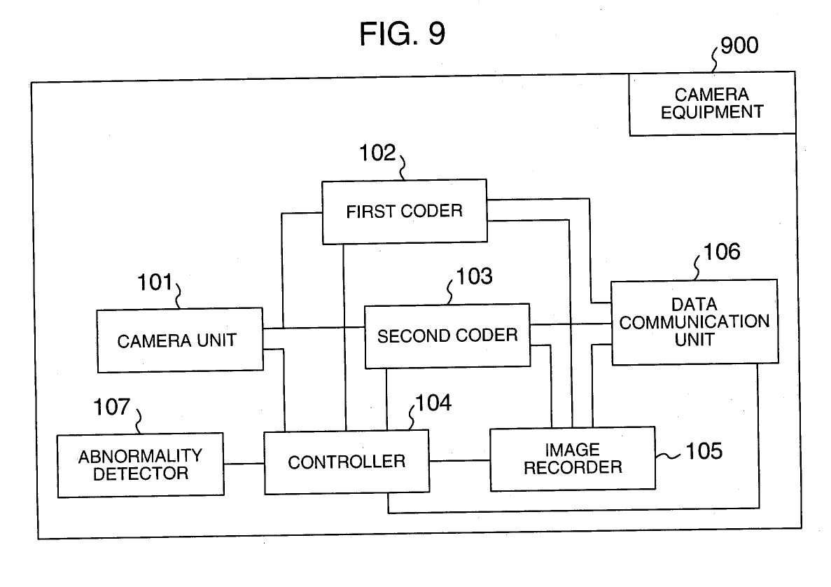

A camera equipment according to a second embodiment of the invention will be explained with reference to FIGS. 9-12.

FIG. 9 is a diagram showing an example of an overall configuration of a camera equipment according to this embodiment. Numeral 900 designates a camera equipment, and numeral 107 an abnormality detector for detecting an abnormality which may occur in the camera equipment 900 including a sensor, etc.

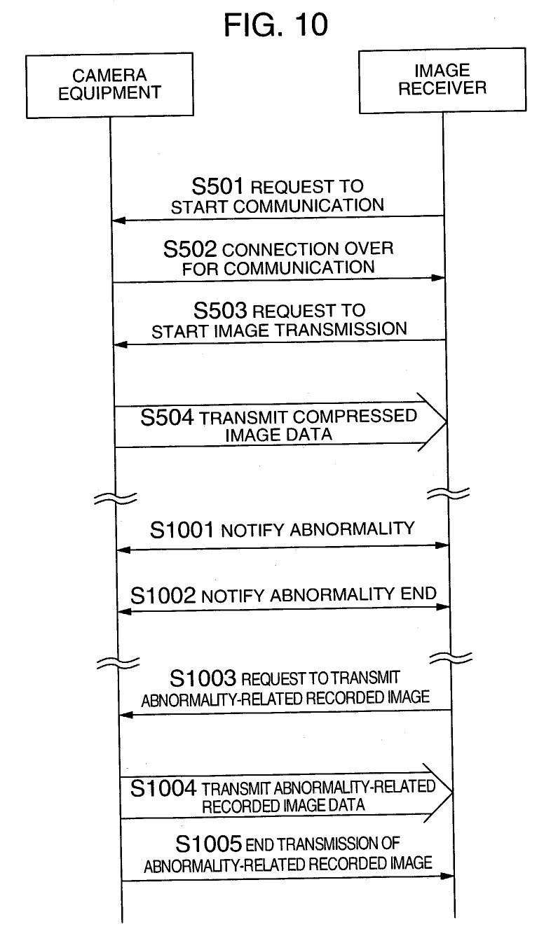

FIG. 10 is a diagram showing the operation sequence of the camera equipment 900 according to this embodiment connected to the image receiver 300 through the network 401, including the operation sequence for starting the transmission of the compressed image data, the operation sequence followed upon occurrence of an abnormality of the camera equipment 900 and the operation sequence for transmitting the compressed image data recorded during an abnormality.

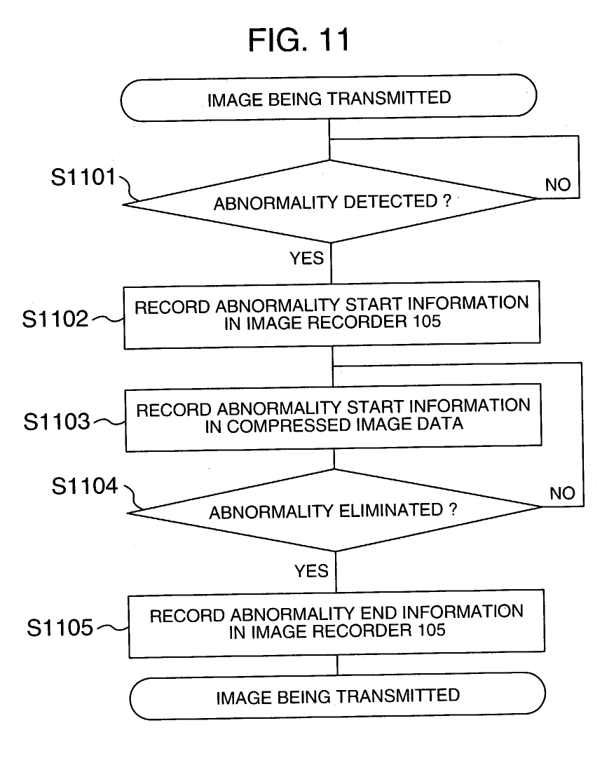

FIG. 11 is a flowchart showing the processing sequence controlled by the controller 104 for controlling the operation of the camera equipment 900 according to this embodiment connected to the image receiver 300 through the network 401, in such a manner that upon detection of an abnormality during the transmission of the compressed image data, the abnormality information is recorded and upon elimination of the abnormality, the abnormality end information is recorded.

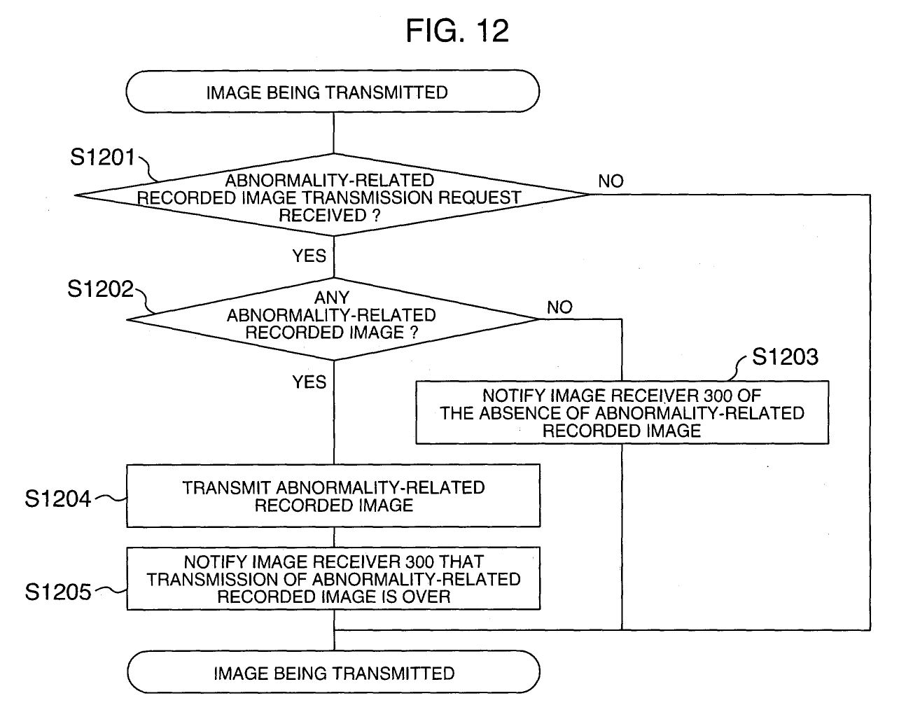

FIG. 12 is a flowchart showing the processing sequence controlled by the controller 104 for controlling the operation of the camera equipment 900 according to the embodiment of the invention connected to the image receiver 300 through the network 401, in such a manner that upon receipt of a request to transmit the compressed image data recorded during the abnormality, the compressed image data associated with the abnormality is transmitted.

The operation of the camera equipment 900 performed upon detection of an abnormality such as a sensor input by the abnormality detector 107 during the transmission of the compressed image data to the image receiver 300, will be explained with reference to FIGS. 3, 4, 9, the operation sequence diagram of FIG. 10 and the flowcharts of FIGS. 11 and 12.

As in the operation of the first embodiment, the camera equipment 900, like the camera equipment 100 shown in FIG. 4, is connected to the network 401 together with a plurality of other camera equipments and the image receiver 300. The camera equipment 900, like in the first embodiment, transmits the compressed image data to the image receiving nit 300 connected therewith for communication (S501 to S504). The image data acquired and generated in the camera unit 101 is compression-coded by the first coder 102 and the second coder 103 according to two compression schemes including MPEG4 and MPEG2, respectively, the image data compressed according to MPEG4 is transmitted to the image receiver 300 through the network 401, and the image data compressed according to MPEG2, on the other hand, is recorded in the image recorder 105. For compression coding according to MPEG4, the compression rate is set in such a manner as to secure a transmission rate in keeping with the transmission capacity of the network 401, while the compression coding according to MPEG2 produces a higher quality than the compressed image data generated by the compression coding according to MPEG4.

Upon receipt of the notice that the abnormality detector 107 has detected an abnormality (S1101), the controller 104 stores the abnormality start information in the image recorder 105 (S1102) and notifies the abnormality information to the image receiving unit 300 through the data communication unit 106 (S1001). After that, the compressed image data coded by the second coder 103 is recorded together with the abnormality information in the image recorder 105 (S1103). Thereafter, the controller 104 regularly checks to see whether the abnormality has been eliminated or not (S1104), and in the case where the abnormality is yet to be eliminated, the compressed image data generated by the second coder 103 is again recorded together with the abnormality information (S1103). In the case where the abnormality is eliminated, on the other hand, the abnormality end information is stored in the image recorder 105 (S1105) and notified to the image receiver 300 through the data communication unit 106 (S1002).

The controller 104, upon receipt of an abnormality-related image transmission request from the image receiver 300 (S1003) (S1201), checks with the image recorder 105 to see whether the compressed image data recorded during the abnormality is available or not (S1202), and in the absence of such compressed image data, the abnormality-related image absence is notified to the image receiver 300 (S1203). In the presence of the compressed image data recorded during the abnormality, on the other hand, the compressed image data recorded in the image recorder 105 during the abnormality (hereinafter referred to as the abnormality-related compressed image data) is transmitted to the image receiver 300 (S1004) (S1204). Upon complete transmission of the abnormality-related compressed image data, the image receiver 300 is notified that the compressed image data recorded during the abnormality has been transmitted completely (S1005) (S1205). This series of operations makes it possible to transmit to the image receiver 300 a detailed image associated with an abnormality which the camera equipment 900 may detect during the transmission of the compressed image data.

The image receiver 300 has issued a request to the camera equipment 900, after connection is established for communication, to transmit the compressed image data according to MPEG4. Thus, the decoder 302 is operating for decoding the compressed image data according to MPEG4. In the case where the abnormality-related compressed image data generated by the second coder 103 operating according to MPEG2 is received, therefore, the decoder 302 is switched to MPEG2. In this way, the received abnormality-related compressed image data can be checked by being displayed on the display unit 303. According to this embodiment, the image data is compression-coded by the first coder 102 according to MPEG4 at the request of the image receiver 300, while the second coder 103 performs the compression-coding operation according to MPEG2 under the control of the controller 104. Nevertheless, the second coder 103 may be set to another compression coding scheme.

According to this embodiment, the image data is compression-coded by the first coder 102 according to MPEG4 at the request of the image receiver 300, while the second coder 103 compression-codes the image data according to MPEG2 under the control of the controller 104, as explained above. Nevertheless, the second coder 103 may also be set to an arbitrary compression coding scheme at the request of the image receiver 300.

In this embodiment, the image data compressed by the second coder 103 is recorded in the image recorder 105. Nevertheless, the image data compressed by the first coder 102 may alternatively be recorded in the image recording unit 105. In the latter case, upon receipt of an abnormality-related recorded image transmission request from the image receiver 300, the abnormality-related compressed image data recorded in the image recorder 105 which is compressed in either the first coder 102 or the second coder 103 may be transmitted. As another alternative, the compressed image data as required by the image receiver 300 may be selectively transmitted.

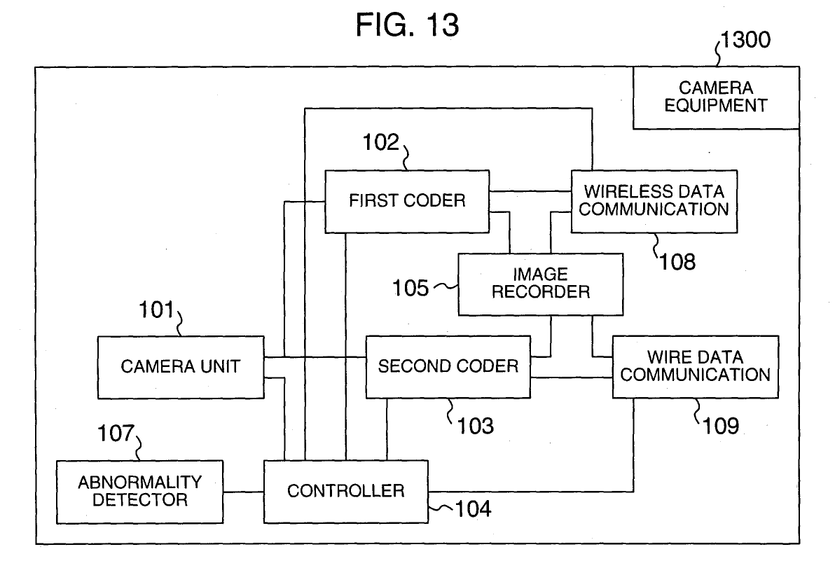

A camera equipment according to a third embodiment of the invention will be explained with reference to FIGS. 13-18.

FIG. 13 is a diagram showing an overall block configuration of a camera equipment according to the third embodiment of the invention. Numeral 1300 designates a camera equipment, numeral 108 a wireless data communication unit for transmitting by radio the compressed image data compression-coded in the first coder 102, and numeral 109 a wire data communication unit for transmitting by wire the compressed image data compression-coded in the second coder 103.

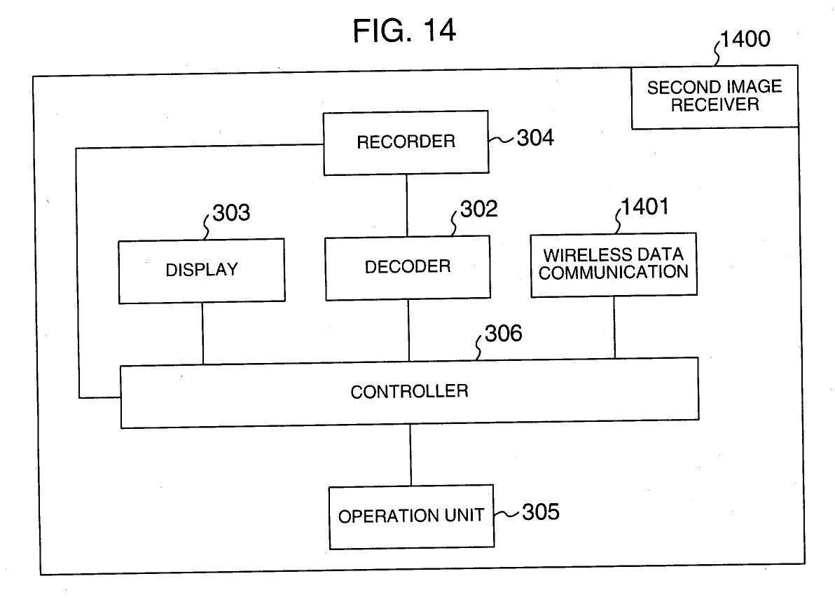

FIG. 14 is a diagram showing an example of a block configuration of a second image receiver constituting a destination of the compressed image data transmitted from the camera equipment 1300 according to this embodiment. Numeral 1400 designates a second image receiver, and numeral 1401 a wireless data communication unit for transmitting and receiving the data by radio to and from the camera equipment 1300.

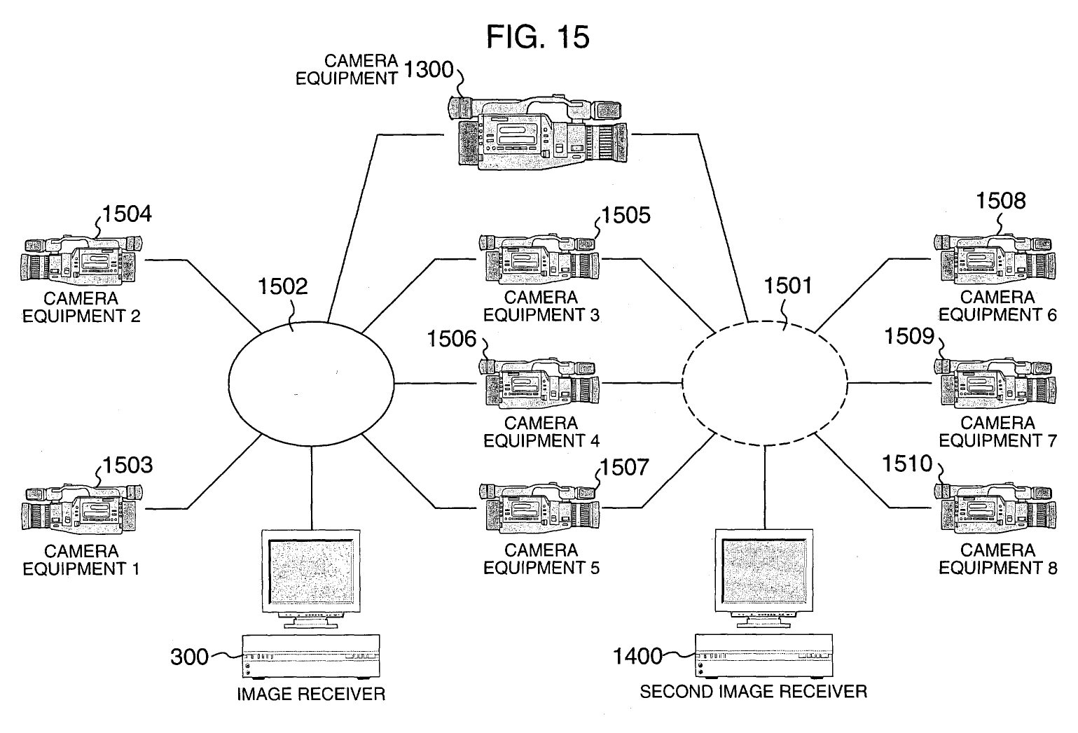

FIG. 15 is a diagram showing an example of a configuration in which the camera equipment 1300 according to this embodiment is connected to a plurality of other camera equipments, the image receiver 300 and a second image receiver 1400 through a wire network and a wireless network. Numeral 1501 designates a wireless network, numeral 1502 a wire network, numeral 1503 a first camera equipment having the same configuration as the camera equipment 100 or the camera equipment 900 and connected to the wire network 1502, numeral 1504 a second camera equipment having the same configuration as the camera equipment 100 or the camera equipment 900 and connected to the wire network 1502, numeral 1505 a third camera equipment having the same configuration as the camera equipment 1300 and connected to the wire network 1502 and the wireless network 1501, numeral 1506 a fourth camera equipment having the same configuration as the camera equipment 1300 and connected to the wire network 1502 and the wireless network 1501, numeral 1507 a fifth camera equipment having the same configuration as the camera equipment 1300 and connected to the wire network 1502 and the wireless network 1501, numeral 1508 a sixth camera equipment having the same configuration as the camera equipment 1300 and connected to the wireless network 1501, numeral 1509 a seventh camera equipment having the same configuration as the camera equipment 1300 and connected to the wireless network 1501, and numeral 1510 an eighth camera equipment having the same configuration as the camera equipment 1300 and connected to the wireless network 1501,

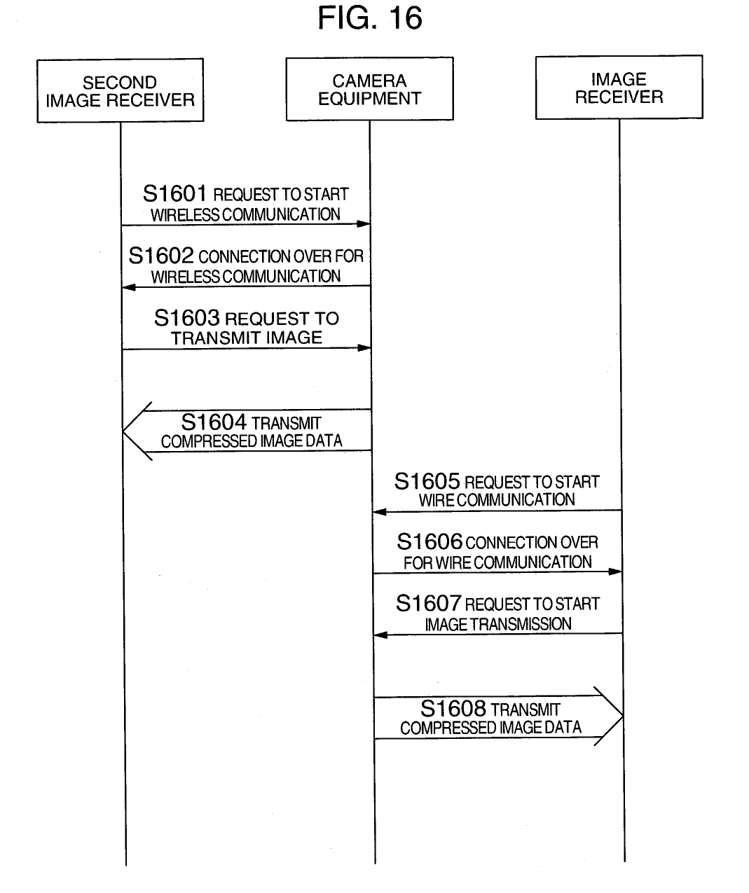

FIG. 16 is a diagram showing the operation sequence for starting the transmission of the compressed image data in the case where the camera equipment 1300 according to this embodiment is connected to the second image receiver 1400 through the wireless network 1501, and the operation sequence for starting the transmission of the compressed image data in the case where the camera equipment 1300 according to this embodiment is connected to the image receiver 300 through the wire network 1502.

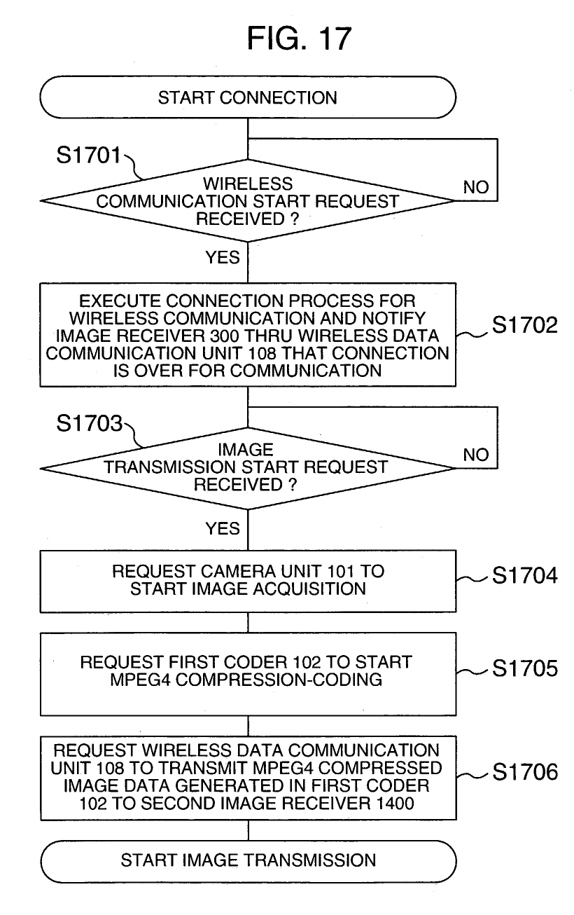

FIG. 17 is a flowchart showing the processing sequence of the controller 104 for controlling the operation in which the camera equipment 1300 according to this embodiment connected to the second image receiver 1400 through the wireless network 1501 starts the compression coding and starts the transmission of the compressed image data thus generated.

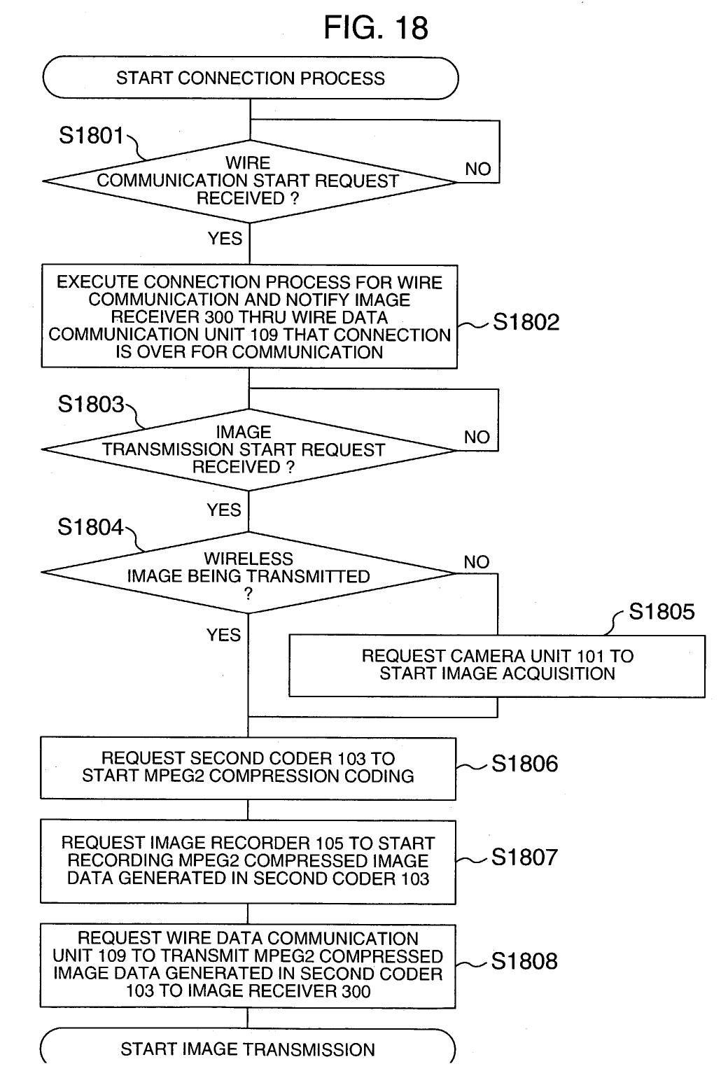

FIG. 18 is a flowchart showing the processing sequence of the controller 104 for controlling the operation in which the camera equipment 1300 according to this embodiment connected to the image receiver 300 through the wire network 1502 starts the compression coding and starts the transmission of the compressed image data thus generated.

The camera equipment 1300 according to this embodiment is connected to image receiver 300 through the wire network 1502 and further to the second image receiver 1400 through the wireless network 1501, transmits the compressed image data generated by the second coder 103 to the image receiver 300, records the compressed image data in the image recorder 105, and further transmits the compressed image data generated by the first coder 102 to the second image receiver 1400. This series of operation will be explained with reference to FIGS. 13, 14, 15, FIG. 16 showing the operation sequence and the flowcharts of FIGS. 17 and 18.

The camera equipment 1300, after receiving a wireless communication start request from the second image receiver 1400 (S1601) by way of the wireless data communication unit 108, sends the same request to the controller 104. The controller 104, upon receipt of the wireless communication start request (S1701), executes the connection process for wireless communication and notifies the second image receiver 1400 through the wireless data receiver 108 that the connection is complete for wireless communication (S1602) (S1702). In response to this notice, the second image receiver 1400 transmits an image transmission start request to the camera equipment 1300 for starting the compression coding according to MPEG4 (S1603). The controller 104, upon receipt of the image transmission start request through the wireless data communication unit 108 (S1703), requests the camera unit 101 to start the image acquisition (S1704). Further, the controller 104 requests the first coder 102 to start the compression coding operation according to MPEG4 of the image data input thereto from the camera unit 101 (S1705). Next, the controller 104 requests the wireless data transmitter 108 to transmit the compressed image data according to MPEG4 generated by the first coder 102 to the second image receiver 1400 (S1604) (S1706).

Next, the wire communication start request received from the image receiver 300 by way of the wire data communication unit 109 (S1605) is sent to the controller 104. The controller 104, upon receipt of the wire communication start request (S1801), executes the process of connection for wire communication and notifies the image receiver 300 through the wire data receiver 109 (S1802) that the connection for wire communication is complete (S1606). In response, the image receiver 300 transmits an image transmission start request to the camera equipment 1300 to start the compression coding according to MPEG2 (S1607). The controller 104, upon receipt of the image transmission start request through the wire data communication unit 109 (S1803), checks to see whether the wireless image transmission is going on or not (S1804). In the case where the wireless image transmission is not going on, the camera unit 101 is requested to start the image acquisition (S1805). In the case where the wireless image transmission is going on, on the other hand, no special operation is performed since the camera unit 101 is already activated at the time of starting the wireless image transmission. Next, the second coder 103 is requested to start the MPEG2 compressing coding of the image data input from the camera unit 101 (S1806). Further, the image recorder 105 is requested to start recording the MPEG2 compressed image data generated by the second coder 103 (S1807). Next, the wire data transmitter 109 is requested to transmit the MPEG2 compressed image data generated by the second coder 103 to the image receiver 300 (S1608) (S1808).

As described above, the image data acquired and generated by the camera unit 101 are compression-coded by two types of compression schemes MPEG4 and MPEG2. The compressed image data generated by MPEG4 is transmitted to the second image receiver 1400 through the wireless network 1501, while the compressed image data generated by MPEG2 is recorded in the image recorder 105 and further transmitted to the image receiver 300 through the wire network 1502. This series of operation prevents the transmission of the compressed image data from being hampered through at least one of the two communication means even in the case where the transmission of the compressed image data is suspended by the degradation or the fault of the wireless or wire communication conditions during the transmission of the compressed image data. Also, even in the case where the two communication means are both degraded, the compressed image data acquired and recorded by the image recorder 105 during the suspension can be recovered after restoration of normal communication.

According to this embodiment, the compressed image data generated by the second coder 103 is recorded in the image recorder 105. Alternatively, the image data compressed by the first coder 102 may be recorded in the image recorder 105.

Also, according to this embodiment, the two types of data communication units include the wireless data communication unit 108 and the wire data communication unit 109. Alternatively, both the two types of the data communication units may be either wire data communication units or wireless data communication units.

According to the first, second and third embodiments, the image data is compression-coded by the first coder 102 according to MPEG4 at the request of the image receiver 300, while the second coder 103 operates for compression coding according to MPEG2 under the control of the controller 104. Alternatively, the first coder 102 and the second coder 103 may operate according to different compression coding schemes such as MPEG1, JPEG or JPEG2000.

According to the embodiments of the invention, a plurality of coders are provided for compression-coding a picked-up image by different compression schemes. In the case where an abnormality occurs in the camera equipment during the transmission of the compressed image data to the destination, the detailed compressed image data related to the abnormality are recorded in the compressed data recorder. Thus, the required image data can be acquired without fail. Also, a compression scheme matching the expansion decoding scheme of the destination can be selected. Further, the compressed image data of a size suitable for the transmission path can be generated, and the compressed image data of high quality can be generated for storage.

Also, the availability of a plurality of wireless and wire transmission paths makes it possible to generate the compressed image data by a compression scheme suitable for each transmission path. Even in the case where one of the transmission paths becomes incapable of communication or in the case where the communication conditions of one transmission path are deteriorated, the other transmission path can be effectively used to transmit the compressed image data acquired by the camera equipment.

It will thus be understood from the foregoing description that according to this invention, even in the case where the camera equipment develops an abnormality during the transmission of the compressed image data to a destination, the required image data can be acquired without fail and transmitted to the destination as required. Also, the compressed image data of a size suitable for the destination can be generated.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A camera equipment comprising:
camera means for outputting a picked-up image as an image data;
first coding means for compression-coding the image data output from said camera means;
second coding means for compression-coding the image data output from said camera means;
communication means for receiving and transmitting the compressed image data compression-coded in said first coding means through a transmission path; and
recording means for storing the compressed image data compression-coded by said first coding means and said second coding means;
wherein said first coding means compression-codes said image data by a compression coding scheme designated externally through said communication means, said compression coding scheme being different from a compression coding scheme employed by said second coding means.

2. A camera equipment according to claim 1,
wherein said first coding means selects one of a plurality of different compression coding schemes and executes a compression coding process designated externally.

3. A camera equipment according to claim 1,
wherein said second coding means compression-codes the image data by the compression coding process designated externally through said communication means.

4. A camera equipment according to claim 1,
wherein said first coding means executes the compression-coding process according to a compression-coding scheme designated externally through said communication means in such a manner as to secure a transmissible data amount satisfying the transmission capacity of the transmission path.

5. A camera equipment according to claim 2,
wherein said second coding means executes the compression-coding process according to a compression-coding scheme designated externally through said communication means in such a manner as to generate a more finely detailed compressed image data than the compressed image data compression-coded by said first coding means.

6. A camera equipment according to claim 1, further comprising means for detecting an abnormality occurring at an image pick-up position, said abnormality being notified to an external unit through said communication means upon detection thereof.

7. A camera equipment according to claim 6,
wherein information indicating the occurrence of an abnormality is added to the compressed image data recorded in said recording means during the occurrence of said abnormality.

8. A camera equipment comprising:
a camera which for outputs a picked-up image as an image data;
a first coder which compression-codes the image data output from said camera;
a second coder which compression-codes the image data output from said camera;
a first communication unit which receives and transmits the compressed image data compression-coded in said first coder through a transmission path;
a second communication unit receives and transmits the compressed image data compression-coded in said second coder through a transmission path different from the transmission path used by said first communication unit; and
a recorder which stores the compressed image data compression-coded by said first coder and said second coder.

9. A camera equipment according to claim 8,
wherein said first communication unit is a wireless communication unit which receives and transmits the image data through a wireless transmission path, and said second communication unit is a wire communication unit for receives and transmits the image data through a wire transmission path.

10. A camera equipment according to claim 8,
wherein said first coder and said second coder compression-code the image data by selectively setting a compression coding scheme designated externally through said first communication unit and said second communication unit, respectively, after connection is established for communication.

11. A camera equipment according to claim 1,
wherein said first coder can select and set one of the compression coding schemes including MPEG1, MPEG2, MPEG4, JPEG and JPEG2000.

12. A camera equipment according to claim 3, wherein each of said first coder and said second coder can independently select and set one of the compression coding schemes including MPEG1, MPEG2, MPEG4, JPEG and JPEG2000.
